(19) United States
(12) Patent Application Publication
(10) Pub. No.: US 2005/0094022 A1
(43) Pub. Date: May 5, 2005

(54) Image capturing apparatus with proximity sensing function

(76) Inventors: Jia-Jen Wang, Taipei City (TW); Li-Min Tseng, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,189

(22) Filed: Oct. 28, 2004

(30) Foreign Application Priority Data
Oct. 31, 2003 (TW) 092130567

(51) Int. Cl. H04N 5/232

(52) U.S. Cl. 348/345

(57) ABSTRACT

An image capturing apparatus with proximity sensing function includes a lens for receiving an image, a focusing module for focusing the image by the lens, an optical sensing device, a shutter for exposing the focused image for a time period, which the focused image is captured by the optical sensing device through the lens, and a first proximity sensor for outputting a first control signal to activate the shutter when the first proximity sensor being activated.

### BACKGROUND OF INVENTION

1. Field of the Invention

The present invention relates to an image capturing apparatus, and more specifically, to an image capturing apparatus with proximity sensing function.

2. Description of the Prior Art

As technology progresses, digital cameras and digital camcorder become indispensable products. Please refer to FIG. 1 showing a front view of a conventional digital camera 10. The digital camera 10 includes a lens 12 for capturing an object, an optical viewfinder 14 composed of a plurality of lenses for viewing the object, and a shutter button 16 for focusing and taking pictures. Please refer to FIG. 2 showing a rear view of the conventional digital camera 10. The digital camera 10 further includes an electric viewfinder 18, which can be a liquid crystal display (LCD) or a low temperature polysilicon (LTPS) display, providing another way to view the object besides the optical viewfinder 14 and a control button set 20 for image editing, browsing, and parameter setup. The digital camera 10 is different from a conventional film camera because it has the electric viewfinder 18 to preview the object or review shot pictures.

Most cameras provide a two-stage shutter; that is, a first press enters the first stage to focus and preview the object with the electric viewfinder, and the second press enters the second stage to capture the image of the object into a memory in the camera. However, a fuzzy picture often results because the camera is not still due to an unsteady hand when shooting a picture, especially when the shutter is slow.

### SUMMARY OF INVENTION

It is therefore a primary objective of the present invention to provide an image capturing apparatus with proximity sensing function in order to solve the problems in the prior art.

Briefly summarized, an image capturing apparatus with proximity sensing function includes a lens for receiving an image, a focusing module for focusing the image by the lens, an optical sensing device, a shutter for exposing the focused image for a time period, which the focused image is captured by the optical sensing device through the lens, and a first proximity sensor for outputting a first control signal to activate the shutter when the first proximity sensor being activated.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a front view of a conventional digital camera.

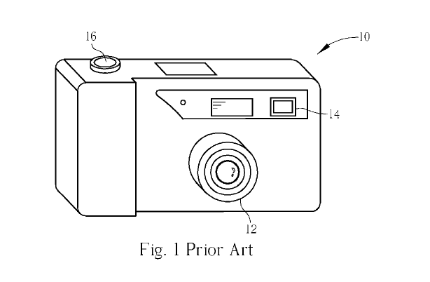

FIG. 2 is a rear view of the conventional digital camera.

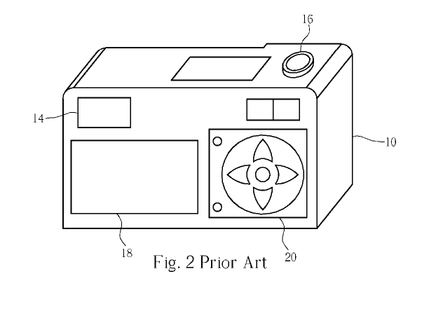

FIG. 3 is a block diagram of an image capturing apparatus according to the present invention.

FIG. 4 is a front view of the image capturing apparatus according to the present invention.

FIG. 5 is a flowchart showing how the image capturing apparatus turns on the focusing module.

FIG. 6 is a flow chart showing how the image capturing apparatus turns on the shutter.

FIG. 7 is a block diagram of the first proximity sensor.

FIG. 8 is a block diagram of the second proximity sensor.

### DETAILED DESCRIPTION

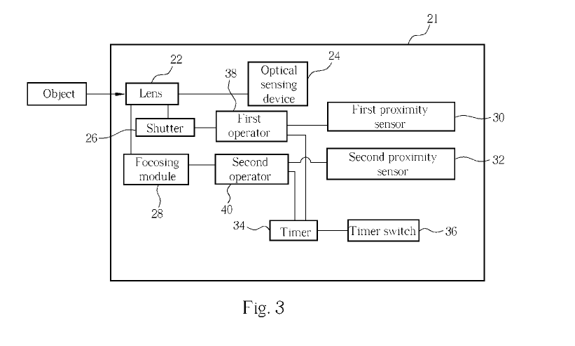

Please refer to FIG. 3 showing a block diagram of an image capturing apparatus 21 according to the present invention. The image capturing apparatus 21 includes a lens 22 for receiving light, an optical sensing device 24 being a plurality of CCD (charge coupled devices) or CMOS (complementary metal-oxide semiconductors) for converting optical signals captured by the lens 22 into electric signals, a shutter 26 for exposing the image taken by the lens 22 to the optical sensing device 24, wherein the exposure can be determined according to the speed of the shutter 26 and an iris (not shown), and a focusing module 28 for controlling the lens 22 to focus. The focusing module 28 can be automatic or manual.

The image capturing apparatus 21 further includes a first proximity sensor 30 and a second proximity sensor 32 being capacitive sensors, inductive sensors, or some other sensors. The first proximity sensor 30 and the second proximity sensor 32 output respectively a first control signal and a third control signal when being activated. The image capturing apparatus 21 further includes a timer 34 for counting time, a timer switch 36 for turning on the timer 34, a first operator 38 electrically connected to the first proximity sensor 30, the timer 34, and the shutter 26 for receiving signals from the first proximity sensor 30 and the timer 34 and outputting corresponding signals to the shutter 26; and a second operator 40 electrically connected to the second proximity sensor 32, the timer 34, and the focusing module 28 for receiving signals from the second proximity sensor 32 and the timer 34 and outputting corresponding signals to the focusing module 28.

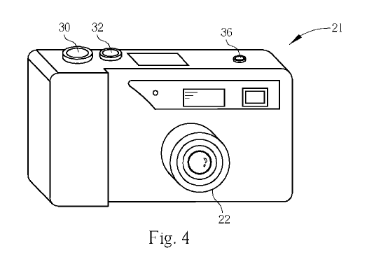

Please refer to FIG. 4 showing a front view of the image capturing apparatus 21. The lens 22 is on the front side of the image capturing apparatus 21. The first proximity sensor 30, the second proximity sensor 32, and the timer switch 36 are on the upper side of the image capturing apparatus 21.

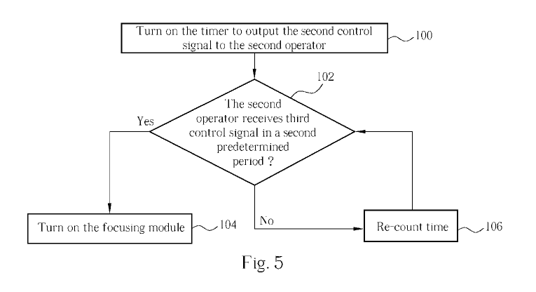

Please refer to FIG. 5 showing a flowchart concerning how the image capturing apparatus 21 turns on the focusing module 28. The operation of the image capturing apparatus 21 is described as follows:

Step100: Control the timer switch 36 to turn on the timer 34. The timer 34 outputs a second control signal to the second operator 40.

Step102: The period since the second operator 40 receives the second control signal until the second operator 40 receives the third control signal is defined as a pre-focus period. If the pre-focus period is shorter than the second predetermined period, proceed to Step 104, and if not, proceed to Step 106. In the other words, if the second operator 40, after receiving the second signal, receives the third control signal output from the second proximity sensor 32 earlier than the second predetermined period expires, proceed to Step104, and if later than that, proceed to Step106.

Step104: The second operator 40 outputs a turn-on signal to the focusing module 28 to focus the lens 22.

Step106: The second operator 40 zeros the pre-focus period for recounting the pre-focus period and the second control signal is output to the second operator 40, and return to Step 102.

When focusing on the object, the user can turn on the timer 34. After being turned on, the timer 34 will output the second control signal to the second operator 40 for a predetermined time, for example 10 seconds. The second operator 40 can be an AND operator; that is, the second operator 40 outputs the turn-on signal to turn on the focusing module 28 after receiving the second control signal from the timer 34 and the third control signal from the second proximity sensor 32. Therefore, focusing will not be executed if only the second proximity sensor 32 or the timer 34 is turned on. A reason why the second operator 40 is enacted with an AND operator is because the second proximity sensor 32 could be turned on by accident. Thus, by using the timer 34, it can be confirmed that the second proximity sensor 32 was turned on according to the user's will.

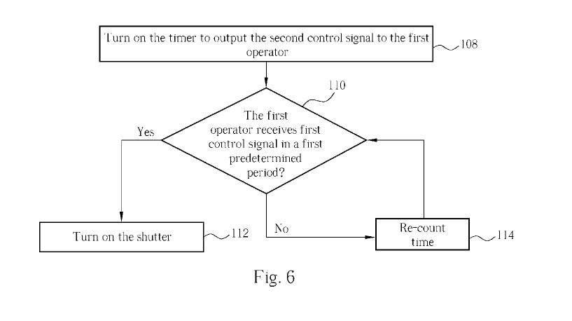

Please refer to FIG. 6 showing a flow chart concerning how the image capturing apparatus 21 turns on the shutter 26 as follows:

Step108: Control the timer switch 36 to turn on the timer 34. The timer 34 outputs the second control signal to the first operator 38.

Step110: If the first operator 38, after receiving the second signal, receives the first control signal output from the first proximity sensor 30 in an activating period earlier than a first predetermined period expires, proceed to Step112, and if later than that, proceed to Step114.

Step112: The first operator 38 outputs the turn-on signal to the shutter 26 to expose the image.

Step114: The first operator 38 zeros the activating period for recounting the activating period, and return to Step 110.

The flow in FIG. 6 is very similar to that in FIG. 5. When focusing on an object, the user can turn on the timer 34. After being turned on, the timer 34 outputs the second control signal to the first operator 38 for a predetermined time, for example 10 seconds. The first operator 38 can be an AND operator; that is, the first operator 38 outputs the turn-on signal to turn on the shutter 26 after receiving the second control signal from the timer 34 and the first control signal from the first proximity sensor 30. Therefore, exposing will not be executed if only the first proximity sensor 30 or the timer 34 is turned on. A reason why the first operator 38 is enacted with an AND operator is because the first proximity sensor 30 could be turned on by accident. Thus, by using the timer 34, it can be confirmed that the first proximity sensor 30 was turned on according to the user's will.

The flows in FIG. 5 and FIG. 6 can be executed independent of each other. Or the following description is also possible: the timer 34 outputs the second control signal to both the first operator 38 and the second operator 40 when turned on. The second operator 40 outputs the turn-on signal to turn on the focusing module 28 only after both receiving the second control signal from the timer 34 and then receiving the third control signal from the second proximity sensor 32 within the second predetermined period, and the first operator 38 outputs the turn-on signal to turn on the shutter 26 only after both receiving the second control signal from the timer 34 and the receiving the first control signal from the first proximity sensor 30 within the first predetermined period. After the second proximity sensor 32 and the focusing module 28 has been turned on, if the user wants to stop shooting, he can simply chooses not to turn on the first proximity sensor 30 in the predetermined period of time. If the user wants to take a picture without focusing the object, he can chooses to turn on the first proximity sensor 30 within the first predetermined period after activating the timer 34 and therefore, the shutter 26 but not to turn on the second proximity sensor 32.

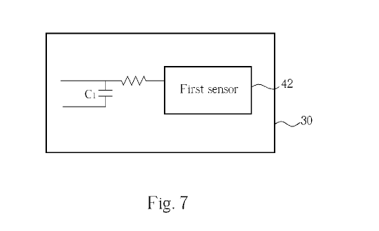

Please refer to FIG. 7 showing a block diagram of the first proximity sensor 30. The first proximity sensor 30 includes a first sensor 42 for receiving a press signal from the outside and a first capacitor C1. The sensitivity of the first proximity sensor 30 can be determined according to the capacity of the first capacitor C1. The sensitivity can be determined by the distance from a finger to the sensor where a finger must move closely enough to the sensor in order to turn on the first proximity sensor 30. The capacity of the first capacitor C1 can be 47 nF.

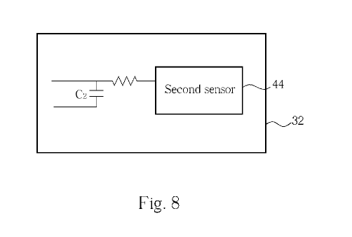

Please refer to FIG. 8 showing a block diagram of the second proximity sensor 32. The second proximity sensor 32 includes a second sensor 44 for receiving a press signal from the outside and a second capacitor C2. The sensitivity of the second proximity sensor 32 can be determined according to the capacity of the second capacitor C2. The sensitivity can be determined by the distance from a finger to the sensor where a finger must move closely enough to the sensor in order to turn on the second proximity sensor 32. The capacity of the second capacitor C2 can be 47 nF.

The above description is an embodiment of the present invention. The image capturing apparatus according to the present invention can be a digital camera, a film camera, a digital camcorder, a tape recorder, or any image capturing apparatus. The present invention utilizes the proximity sensors to assist in image capturing in order to prevent image fuzziness due to an unsteady hand.

In contrast to the prior art, the image capturing apparatus according to the present invention provides proximity sensors so that the user does not need to press the shutter button but only touch the proximity sensors when taking a picture. In such a manner, image fuzziness due to unsteady hands can be prevented. Furthermore, the present invention also provides a timer to confirm that the proximity sensors have been turned on according to the user's will.

Those skills in the art will readily observe that numerous modifications and alterations of the device may be made while retaining the teachings of the invention. Accordingly, the above disclosure should be construed as limited only by the metes and bounds of the appended claims.

1. An image capturing apparatus with proximity sensing function comprising:
a lens for receiving an image;
a focusing module for focusing the image by the lens;
an optical sensing device;
a shutter for exposing the focused image for a time period, the focused image captured by the optical sensing device through the lens; and
a first proximity sensor for outputting a first control signal to activate the shutter when the first proximity sensor being activated.

2. The image capturing apparatus of claim 1 wherein the first proximity sensor further comprises a capacitor for determining the sensitivity of the first proximity sensor.

3. The image capturing apparatus of claim 1 further comprising:
a first operator for turning on the shutter;
a timer for counting time; and
a timer switch for turning on the timer,
wherein when the timer is turned on by the timer switch, the timer outputs a second control signal to the first operator, and when the first operator receives the first control signal and the second control signal, the first operator activates the shutter.

4. The image capturing apparatus of claim 3 wherein the first operator activates the shutter when receiving the first control signal within an activating period shorter than a first predetermined period after the first operator receives the second control signal.

5. The image capturing apparatus of claim 4 wherein if the activating period is longer than the first predetermined period and the first operator does not receive the first control signal, the first operator zeros the activating period.

6. The image capturing apparatus of claim 3 further comprising
a second operator for activating the focusing module wherein when the timer is turned on by the timer switch, the timer outputs the second control signal to the second operator; and
a second proximity sensor for outputting a third control signal to the second operator;
wherein when the second operator receives the second control signal and the third control signal, the second operator activates the focusing module.

7. The image capturing apparatus of claim 6 wherein the second operator activates the focusing module when receiving the third control signal within a pre-focusing period shorter than a second predetermined period after the second operator receives the second control signal.

8. The image capturing apparatus of claim 7 wherein if the pre-focusing period is longer than the second predetermined period and the second operator does not receive the third control signal, the second operator zeros the pre-focusing period.

9. The image capturing apparatus of claim 4 wherein the second proximity sensor further comprises a capacitor for determining the sensitivity of the second proximity sensor.

10. The image capturing apparatus of claim 1 wherein the first proximity sensor is an inductive sensor.

11. The image capturing apparatus of claim 1 wherein the first proximity sensor is a capacitive sensor.

12. The image capturing apparatus of claim 6 wherein the second proximity sensor is an inductive sensor.

13. The image capturing apparatus of claim 6 wherein the second proximity sensor is a capacitive sensor.

14. The image capturing apparatus of claim 1 being a digital camera.

15. A method for capturing an image in use of an image capturing apparatus, the image capturing apparatus comprising a shutter, and a focusing module, the method comprising:
(a) providing a timer and activating the timer to output a second control signal;
(b) providing a first proximity sensor and activating the first proximity sensor to output a first control signal; and
(c) if the shutter receives the first control signal and the second control signal, the shutter being activated, and if the shutter does not receive the first control signal and the second control signal, the shutter not being activated.

16. The method of claim 15 further comprising:
(d) providing a second proximity sensor and activating the second proximity sensor to output a third control signal; and
(e) if the focusing module receives the second control signal and the third control signal, the focusing module being activated, and if the focusing module does not receive the second control signal and the third control signal, the focusing module not being activated.

17. The method of claim 15 wherein step (c) further comprises providing a first operator, wherein the first operator activates the shutter when receiving the first control signal and the second control signal and the first operator does not activate the shutter when not receiving the first control signal and the second control signal.

18. The method of claim 15 wherein step (c) further comprises the first operator activating the shutter when receiving the first control signal within an activating period shorter than a first predetermined period after the first operator receives the second control signal.

19. The method of claim 18 wherein if the activating period is longer than the first predetermined period and the first operator does not receive the first control signal, the first operator zeros the activating period.

20. The method of claim 16 wherein step (e) further comprises providing a second operator, wherein the second operator activates the focusing module when receiving the second control signal and the third control signal and the second operator does not activate the focusing module when not receiving the second control signal and the third control signal.

21. The method of claim 20 wherein step (e) further comprises the second operator activating the focusing module when receiving the third control signal within a pre-focusing period shorter than a second predetermined period after the second operator receives the second control signal.

22. The method of claim 21 wherein if the pre-focusing period is longer than the second predetermined period and the second operator does not receive the third control signal, the second operator zeros the pre- focusing period.
